(19) United States
(12) Patent Application Publication
(10) Pub. No.: US 2019/0312262 A1
(43) Pub. Date: Oct. 10, 2019

(54) NONAQUEOUS ELECTROLYTE SECONDARY BATTERY

(71) Applicant: Panasonic Corporation, Osaka (JP)

(72) Inventors: Naoya Morisawa, Hyogo (JP); Takanobu Chiga, Osaka (JP); Kazuhiro Iida, Tokyo (JP); Atsushi Fukui, Hyogo (JP)

(73) Assignee: Panasonic Corporation, Osaka (JP)

(21) Appl. No.: 16/450,050

(22) Filed: Jun. 24, 2019

Related U.S. Application Data
(63) Continuation of application No. PCT/JP2017/037435, filed on Oct. 17, 2017.

(30) Foreign Application Priority Data
Dec. 28, 2016 (JP) 2016-255234

(51) Int. Cl. H01M 4/36; H01M 4/525; H01M 10/0569; H01M 4/62; H01M 10/0525; H01M 10/0567

(52) U.S. Cl. CPC H01M 4/362; H01M 4/525; H01M 10/0569; H01M 2004/028; H01M 10/0525; H01M 10/0567; H01M 4/62

(57) ABSTRACT

A nonaqueous electrolyte secondary battery including a positive electrode containing a positive electrode mixture, a negative electrode, and a nonaqueous electrolyte containing a nonaqueous solvent and a lithium salt dissolved in the nonaqueous solvent. The positive electrode mixture contains a positive electrode active material and a phosphate salt, the positive electrode active material contains a lithium-nickel composite oxide represented by formula (1): LiₓNi_{1-y}M1_{y}O₂ (in the formula, 0.9≤x≤1.1, 0≤y≤0.7, and M1 is at least one element selected from the group consisting of Co, Mn, Fe, Ti, Al, Mg, Ca, Sr, Zn, Y, Yb, Nb, Cr, V, Zr, Mo, W, Cu, In, Sn, and As), and the nonaqueous solvent contains a trifluoropropionate ester represented by formula (2): F₃C—CH₂—CO—O—R1 (in the formula, R1 is a C₁₋₃ alkyl group).

### TECHNICAL FIELD

The present invention relates to a nonaqueous electrolyte secondary battery including a positive electrode which contains a lithium-nickel composite oxide and a phosphate salt.

### BACKGROUND ART

With the aim for higher capacity in nonaqueous electrolyte secondary batteries such as a lithium ion secondary battery and the like, there are studies on the use of a composite oxide (hereinafter, a lithium-transition metal composite oxide) containing an element such as nickel, cobalt, or the like and lithium as a positive electrode active material. Batteries using such a positive electrode active material have a higher positive electrode potential during charge. Therefore, nonaqueous electrolytes are required to have high oxidation resistance for suppressing oxidative decomposition of the nonaqueous electrolytes due to positive electrodes.

Patent Literature 1 teaches that containing of a fluorinated chain carboxylic acid ester having a specified structure suppresses the reaction of a positive electrode with a nonaqueous electrolyte and thus improves oxidation resistance of the nonaqueous electrolyte. On the other hand, in a case using such a fluorinated chain carboxylic acid ester, the reduction resistance of the nonaqueous electrolyte is decreased, thereby increasing reactivity with a negative electrode. Therefore, Patent Literature 1 proposes that the reaction of the negative electrode with the nonaqueous electrolyte is suppressed by forming a suitable coating film on the negative electrode. Specifically, it is proposed that a coating film-forming compound such as fluoroethylene carbonate or the like is contained, together with the fluorinated chain carboxylic acid ester, in the nonaqueous electrolyte. Thus, it is disclosed that a high initial charge-discharge efficiency and excellent durability characteristics under high-temperature conditions can be achieved.

### CITATION LIST

### Patent Literature

PTL 1: Japanese Published Unexamined Patent Application No. 2009-289414

### SUMMARY OF INVENTION

In recent years, for the purpose of further increasing the capacity of a battery, there has been demand to use a lithium transition metal composite oxide having a high nickel content as a positive electrode active material.

A positive electrode active material can be produced by mixing and firing a plurality of raw materials. With a high nickel content, the resultant positive electrode active material has low heat resistance, and thus a firing temperature is required to be decreased as compared with the case of a low nickel content. As a result, the residual amount of alkali components contained in the produced positive electrode active material tends to be increased. Also, alkali components such as lithium hydroxide, lithium carbonate, and the like derived from the raw materials remain in the positive electrode active material.

The remaining alkali components react with the fluorinated chain carboxylic acid ester contained in the nonaqueous electrolyte, and the reaction products move to the negative electrode. Thus, the use of the positive electrode active material with a high nickel content leads to an increase in amount of the products produced by the reaction of the remaining alkali components with the fluorinated chain carboxylic acid ester and moving to the negative electrode. Thus, a good coating film is not formed on the negative electrode, and a coating film having nonuniform thickness is formed. Therefore, a plurality of batteries formed in the same manner cause variation in open-circuit voltage (OCV) and thus have the problem of destabilizing the quality of the batteries.

An object of the present invention is to suppress variation in open-circuit voltage between batteries using a positive electrode active material having a high nickel content.

A nonaqueous electrolyte secondary battery of the present disclosure includes a positive electrode containing a positive electrode mixture, a negative electrode, and a nonaqueous electrolyte containing a nonaqueous solvent and a lithium salt dissolved in the nonaqueous solvent, the positive electrode mixture containing a positive electrode active material and a phosphate salt. The positive electrode active material contains a lithium-nickel composite oxide represented by formula (1): LiₓNi_{1-y}M1_{y}O₂ (in the formula, 0.9≤x≤1.1, 0≤y≤0.7, and M1 is at least one element selected from the group consisting of Co, Mn, Fe, Ti, Al, Mg, Ca, Sr, Zn, Y, Yb, Nb, Cr, V, Zr, Mo, W, Cu, In, Sn, and As). The nonaqueous solvent contains trifluoropropionate ester represented by formula (2):

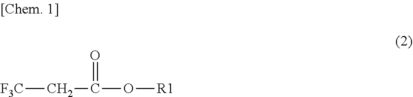

(In the formula, R1 is a C₁₋₃ alkyl group.)

The nonaqueous electrolyte secondary battery according to the present disclosure has a good coating film formed on the negative electrode even when the positive electrode active material having a high nickel content is used, and thus can suppress variation in open-circuit voltage between batteries.

### BRIEF DESCRIPTION OF DRAWINGS

FIG. 1 is a partially exploded perspective view schematically showing a cross-section of the inner structure of a nonaqueous electrolyte secondary battery according to an embodiment of the present invention.

### DESCRIPTION OF EMBODIMENTS

A nonaqueous electrolyte secondary battery according to an embodiment of the present invention includes a positive electrode, which contains a positive electrode mixture, a negative electrode, and a nonaqueous electrolyte. The positive electrode mixture contains a positive electrode active material and a phosphate salt.

The positive electrode active material contains a lithium-nickel composite oxide represented by formula (1): LiₓNi_{1-y}M1_{y}O₂ (in the formula, 0.9≤x≤1.1, 0≤y≤0.7, and M1 is at least one element selected from the group consisting of Co, Mn, Fe, Ti, Al, Mg, Ca, Sr, Zn, Y, Yb, Nb, Cr, V, Zr, Mo, W, Cu, In, Sn, and As).

The nonaqueous solvent contained in the nonaqueous electrolyte contains a trifluoropropionate ester represented by formula (2):

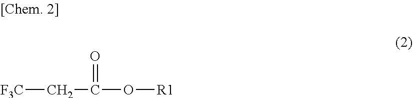

(in the formula, R1 is a C₁₋₃ alkyl group).

In the configuration described above, the products such as difluoroacrylate and the like, which are produced by the reaction of the alkali components remaining in the positive electrode active material with the trifluoropropionate ester contained in the nonaqueous electrolyte, reacts with the phosphate salt contained in the positive electrode, thereby suppressing movement of the products to the negative electrode. In order to achieve the effect of the phosphate salt, an alkaline phosphate salt such as lithium phosphate or the like is preferably used as the phosphate salt contained in the positive electrode.

When the movement of the products such as difluoroacrylate and the like to the negative electrode is suppressed, a uniform coating film, as a result, can be formed on the negative electrode, and thus variation in open-circuit voltage between batteries can be suppressed.

Next, details of the constituent elements of the nonaqueous electrolyte secondary battery according to the embodiment are illustratively described.

[Positive Electrode]

The positive electrode includes a positive electrode current collector and a positive electrode mixture layer (positive electrode active material layer) formed on the surface of the positive electrode current collector. The positive electrode mixture contains the positive electrode active material and the phosphate salt.

The positive electrode active material contains a lithium-nickel composite oxide represented by formula (1): LiₓNi_{1-y}M1_{y}O₂ (in the formula, 0.9≤x≤1.1, 0≤y≤0.7, and M1 is at least one element selected from the group consisting of Co, Mn, Fe, Ti, Al, Mg, Ca, Sr, Zn, Y, Yb, Nb, Cr, V, Zr, Mo, W, Cu, In, Sn, and As).

When the positive electrode active material contains the lithium-nickel composite oxide (also referred to as the “lithium-nickel composite oxide (1)” hereinafter) having a high nickel content and represented by the formula (1), a battery having high capacity can be obtained.

A method for synthesizing the lithium-nickel composite oxide (1) is not particularly limited. For example, the lithium-nickel composite oxide (1) can be synthesized by adding an alkali to an aqueous solution, containing a nickel compound and a compound containing element M1 at a predetermined molar ratio, to produce a hydroxide (Ni_{1-y}M1_{y}(OH_{Z}))) by a coprecipitation method, converting the resultant hydroxide to an oxide, then mixing the oxide with a lithium compound, and firing the resultant mixture.

Usable examples of the nickel compound include nickel sulfate salts, nitrate salts, hydroxides, oxides, halides, and the like. Usable examples of the compound of element M1 include sulfate salts, nitrate salts, hydroxides, oxides, halides, and the like of the element M1. Usable examples of the lithium compound include lithium hydroxide, lithium oxide, lithium carbonate, and the like. Among these, lithium hydroxide is preferred in view of its excellent reactivity.

The firing temperature and firing time may be properly determined according to the structure and size of the target lithium-nickel composite oxide (1) as long as firing is performed at a temperature higher than the melting temperature of the lithium compound and lower than the heat resistant temperature of the lithium-nickel composite oxide (1).

The alkali components remaining in the lithium-nickel composite oxide (1) obtained after firing include the unreacted lithium compound, lithium carbonate produced by the reaction of a part of the unreacted lithium compound with carbon dioxide in the atmosphere, etc. In particular, in the case of a high nickel content, the heat resistance of the lithium-nickel composite oxide (1) is decreased, and thus the firing temperature is required to be decreased, resulting in the tendency to increase the amount of the alkali components remaining.

The lithium-nickel composite oxide (1) obtained after firing is used as the positive electrode active material directly or after water washing. Even with a large amount of the alkali components remaining, the coating film on the negative electrode can be suppressed from being made nonuniform by mixing with the phosphate salt. However, in order to achieve the high effect of the phosphate salt, the lithium-nickel composite oxide (1) used as the positive electrode active material is preferably such that when the positive electrode mixture is dispersed in pure water and sufficiently stirred, the amount of lithium eluted in the water is 0.01% to 0.2% by mass of the positive electrode mixture. In order to the higher effect of the phosphate salt, the lithium-nickel composite oxide (1) is preferably washed with water. Water washing preferably decreases the amount of lithium eluted in the water to 0.01% to 0.05% by mass of the positive electrode mixture when the positive electrode mixture is dispersed in pure water and sufficiently stirred.

The lithium-nickel composite oxide (1) can be singly used as the positive electrode active material, but may be used in combination with another positive electrode active material. Examples of the other positive electrode active material include a lithium-nickel composite oxide other than the lithium-nickel composite oxide (1), a lithium-cobalt composite oxide, a lithium-manganese composite oxide, and the like. In the case of combination with the other positive electrode active material, in order to obtain a battery with high capacity, the content of the lithium-nickel composite oxide (1) is preferably 50% by mass or more of the total of the positive electrode active materials.

The alkali components remaining in the positive electrode active material react with the trifluoropropionate ester (also referred to as the “trifluoropropionate ester (2)” hereinafter) contained in the nonaqueous electrolyte and represented by formula (2):

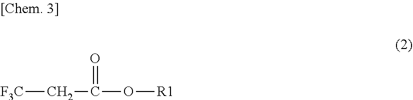

(in the formula, R1 is a C₁₋₃ alkyl group), producing products such as difluoroacrylate and the like. The phosphate salt contained in the positive electrode mixture may be a phosphate salt capable of reacting with the products. The positive electrode mixture containing such a phosphate salt can suppress the movement of the reaction products to the negative electrode. As a result, a uniform coating film can be formed on the negative electrode, and thus variation in open-circuit voltage between batteries can be suppressed.

The phosphate salt is preferably an alkaline phosphate salt, and usable examples thereof include lithium phosphate (Li₃PO₄), sodium phosphate, potassium phosphate, and the like. In view of the high reactivity with the products such as difluoroacrylate and the like, lithium phosphate is particularly preferably used.

The average particle diameter D (μm) and specific surface area S (m²/g) of the phosphate salt used in the present invention are not particularly limited. In view of the satisfactory reactivity of the alkali components remaining in the positive electrode active material with the trifluoropropionate ester (2) contained in the nonaqueous electrolyte, a small average particle diameter D (μm) and large specific surface area S (m²/g) are preferred, and in particular, the ratio: S/D of the specific surface area S (m²/g) to the average particle diameter D (μm) is preferably 5 or more and more preferably 25 to 100.

The average particle diameter D (μm) of the phosphate salt is a median diameter (D50) measured by, for example, a laser diffraction particle size distribution analyzer. Also, the specific surface area S (m²/g) of the phosphate salt is a BET specific surface area measured by, for example, a gas adsorption method.

The amount of the phosphate salt in the positive electrode mixture is preferably 0.01% to 10% by mass and more preferably 0.1% to 1% by mass. With the decreased amount of the phosphate salt, an improving effect may not be satisfactorily obtained by the reaction of the phosphate salt with the reaction products of the alkali components, remaining in the positive electrode active material, with the trifluoropropionate ester (2) contained in the nonaqueous electrolyte. On the other hand, with the excessively large amount of the phosphate salt, the discharge capacity is decreased.

Besides the positive electrode active material and the phosphate salt, the positive electrode mixture may contain a binder.

Examples of the binder include fluorocarbon resins such as polytetrafluoroethylene, polyvinylidene fluoride, and the like; polyolefin resins such as polyethylene, polypropylene, and the like; polyamide resins such as aramid and the like; polyimide resins such as polyimide, polyamide-imide, and the like; rubber materials such as styrene-butadiene rubber, acrylic rubber, and the like; and the like. The binders can be used alone or in combination of two or more. The amount of the binder is, for example, 0.1 to 10 parts by mass relative to 100 parts by mass of the positive electrode active material.

If required, the positive electrode mixture may contain a conductive material and further a thickener.

Examples of the conductive material include carbon black, graphite, carbon fibers, carbon fluoride, and the like. The conductive materials can be used alone or in combination of two or more. The amount of the conductive material is, for example, 0.1 to 10 parts by mass relative to 100 parts by mass of the positive electrode active material.

Examples of the thickener include cellulose derivatives such as carboxymethyl cellulose (CMC), CMC sodium salts, and the like; poly C₂₋₄ alkylene glycols such as polyethylene glycol, ethylene oxide-propylene oxide copolymer, and the like; polyvinyl alcohol; solubilized modified rubber; and the like. The thickeners can be used alone or in combination of two or more. The amount of the thickener is not particularly limited, but is, for example, 0.01 to 10 parts by mass relative to 100 parts by mass of the positive electrode active material.

Examples of the positive electrode current collector include, besides a metal foil, porous substrates such as a punching sheet, an expand metal, and the like. Examples of a material of the positive electrode current collector include stainless steel, titanium, aluminum, aluminum alloys, and the like.

The positive electrode active material layer may be formed on one or both surfaces of the positive electrode current collector. The positive electrode is formed by mixing the positive electrode mixture with a dispersion medium to prepare a positive electrode paste, applying the paste on the surface of the positive electrode current collector, and drying the paste. Examples of the dispersion medium include, but are not limited to, water, alcohols such as ethanol and the like, ethers such as tetrahydrofuran and the like, amides such as dimethylformamide and the like, N-methyl-2-pyrrolidone (NMP), and mixed solvents thereof, and the like.

The positive electrode paste is prepared by a method using a common mixer or kneader, and is applied on the surface of the positive electrode current collector by a common coating method. The dry coating film of the positive electrode mixture formed on the surface of the positive electrode current collector is generally compressed in the thickness direction to form the positive electrode active material layer.

[Negative Electrode]

The negative electrode includes a negative electrode current collector and a negative electrode active material layer adhering to the negative electrode current collector. Examples of the negative electrode current collector include those described for the positive electrode current collector. Examples of a material of the negative electrode current collector include stainless steel, nickel, copper, copper alloys, aluminum, aluminum alloys, and the like.

The negative electrode active material layer contains a negative electrode active material as an essential component and contains a binder, a conductive material and/or a thickener as optional components. The negative electrode active material layer may be formed on one or both surfaces of the negative electrode current collector.

The negative electrode may be a negative electrode mixture layer containing the negative electrode active material and the binder, and if required, the conductive material and/or the thickener or may be a deposited film of the negative electrode active material.

The negative electrode including the negative electrode mixture layer can be formed according to the method for forming the positive electrode. The components other than the active material are the same as those used for forming the positive electrode. The amount of each of the components relative to 100 parts by mass of the negative electrode active material can be selected from the amounts relative to 100 parts by mass of the positive electrode active material described for the positive electrode. The amount of the binder is, for example, 0.1 to 10 parts by mass relative to 100 parts by mass of the negative electrode active material. The amount of the conductive material is, for example, 0.01 to 5 parts by mass relative to 100 parts by mass of the negative electrode active material. The amount of the thickener is, for example, 0.01 to 10 parts by mass relative to 100 parts by mass of the negative electrode active material.

Examples of the negative electrode active material include carbon materials, silicon compounds such as silicon, silicon oxide, the like, lithium alloys each containing at least one selected from tin, aluminum, zinc, and magnesium, and the like. Examples of the carbon materials include graphite (natural graphite, artificial graphite, and the like), amorphous carbon, and the like.

The deposited film can be formed by depositing the negative electrode active material on the surface of the negative electrode current collector by a gas phase method such as a vacuum deposition method or the like. In this case, usable examples of the negative electrode active material include silicon, silicon compounds, lithium alloys, and the like, which are described above.

[Nonaqueous Electrolyte]

The nonaqueous electrolyte contains the nonaqueous solvent and the lithium salt dissolved in the nonaqueous solvent. The nonaqueous solvent contains a

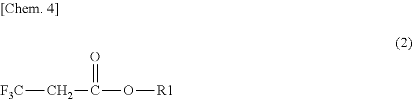

(in the formula, R1 is a C₁₋₃ alkyl group).

The trifluoropropionate ester (2) represented by the formula (2) has high oxidation resistance. Examples of the C₁₋₃ alkyl group represented by R1 in the formula (2) include a methyl group, an ethyl group, a n-propyl group, an i-propyl group, and the like. Among these, a methyl group or an ethyl group is preferred. The trifluoropropionate ester (2), particularly, methyl 3,3,3-trifluoropropionate (FMP) having a methyl group as R1, exhibits high oxidation resistance with low viscosity. Therefore, the trifluoropropionate ester (2) containing FMP is preferably used as the nonaqueous solvent. The ratio of FMP in the trifluoropropionate ester (2) is, for example, 50% by mass or more and preferably 80% by mass or more, and only FMP may be used. The nonaqueous electrolyte may contain one trifluoropropionate ester (2) or two or more trifluoropropionate esters (2) having different R1s.

The trifluoropropionate ester (2) has excellent oxidation resistance while has poor alkali resistance. In the nonaqueous electrolyte secondary battery, particles of the positive electrode active material are expanded and cracked during initial charging, and thus the nonaqueous electrolyte permeates into the particles. Thus, in general, when the nonaqueous electrolyte containing the trifluoropropionate ester (2) is used, the reaction products such as difluoroacrylate and the like, which are produced by reaction of the alkali components remaining in the particles of the positive electrode active material with the trifluoropropionate ester (2), move to the negative electrode and cause nonuniformity of the coating film on the negative electrode. As a result, variation in open-circuit voltage between batteries occur, thereby destabilizing battery quality.

However, when the positive electrode contains the phosphate salt, the phosphate salt reacts with the reaction products such as difluoroacrylate and the like, and thus the movement of the reaction products to the negative electrode can be suppressed. When a usual nonaqueous electrolyte not containing the trifluoropropionate ester (2) is used for the positive electrode containing the phosphate salt, the nonaqueous solvent is decomposed on the alkali phosphate salt disposed on the surface of the positive electrode, but reaction products such difluoroacrylate and the like, having high polymerizability, are not produced. Therefore, the reaction products move to the negative electrode and thus cause nonuniformity of the coating film on the negative electrode.

The amount of the trifluoropropionate ester (2) in the nonaqueous solvent is preferably 10% by volume or more, more preferably 20% by volume or more, and particularly preferably 30% by volume or more. With the amount of the trifluoropropionate ester (2) within the range, the oxidation resistance of the nonaqueous electrolyte is further improved.

The nonaqueous electrolyte contains the lithium salt as a solute. Usable examples of the lithium salt include lithium hexafluorophosphate (LiPF₆), lithium bis(fluorosulfonyl)amide (LiFSA), lithium perchlorate (LiClO₄), lithium tetrafluoroborate (LiBF₄), LiAlCl₄, LiSbF₆, LiSCN, LiCF₃SO₃, LiCF₃CO₂, LiAsF₆, LiN(CF₃SO₂)₂, LiB₁₀Cl₁₀, lithium lower aliphatic carboxylates, LiCl, LiBr, LiI, lithium tetrachloroborate, lithium tetraphenylborate, lithium imide salts, and the like. The lithium salts may be used alone or in combination of two or more. In particular, in the nonaqueous electrolyte using LiFSA, the LiFSA decomposed product produced by oxidative decomposition on the positive electrode reacts with the difluoroacrylate, which is a reaction product of the trifluoropropionate ester (2), to increase the molecular weight, thereby easily fixing on the phosphate salt contained in the positive electrode. Therefore, movement of the reaction products to the negative electrode can be effectively suppressed. The concentration of the lithium salt in the nonaqueous electrolyte is not particularly limited but is preferably 0.2 to 2 mol/L and more preferably 0.5 to 1.5 mol/L.

The nonaqueous electrolyte preferably further contains a carboxylic acid fluoroalkyl ester represented by formula (3) below:

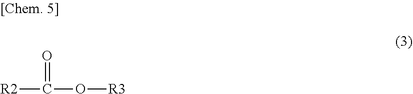

(in the formula, R2 represents a C₁₋₃ alkyl group, and R3 represents a fluorinated C₁₋₃ alkyl group).

The viscosity of the nonaqueous electrolyte is decreased by Containing the carboxylic acid fluoroalkyl ester (3) (hereinafter, referred to as the “carboxylic acid fluoroalkyl ester (3)”) represented by the formula (3). Thus, injection properties during battery formation can be improved.

Like the trifluoropropionate ester (2), the carboxylic acid fluoroalkyl ester (3) reacts with the alkali components remaining in the positive electrode and thus increases the amount of the reaction products moving to the negative electrode. However, the reaction of the reaction products with the phosphate salt contained in the positive electrode can effectively suppress the movement of the reaction products to the negative electrode.

In the carboxylic acid fluoroalkyl ester (3), examples of a C₁₋₃ alkyl group part of each of a C₁₋₃ alkyl group represented by R2 and a fluorinated C₁₋₃ alkyl group represented by R3 include a methyl group, an ethyl group, a n-propyl group and an i-propyl group. The number of fluorine atoms in R3 can be selected from the number of carbon atoms in the C₁₋₃ alkyl group, and is preferably 1 to 5 and more preferably 1 to 3. R2 is preferably a methyl group or an ethyl group, and a methyl group is preferred from the viewpoint of decreasing viscosity. R3 is preferably a trifluoromethyl group, a 2,2,2-trifluoroethyl group, or the like, and a 2,2,2-trifluoroethyl group which can be derived from easily available 2,2,2-trifluoroethanol is particularly preferred.

In particular, the carboxylic acid fluoroalkyl ester (3) is preferably 2,2,2-trifluoroethyl acetate (FEA). Thus, the carboxylic acid fluoroalkyl ester (3) containing at least FEA is preferably used.

The amount of the carboxylic acid fluoroalkyl ester (3) in the nonaqueous electrolyte is, for example, 1% to 60% by mass, preferably 10% to 50% by mass, and more preferably 15% to 45% by mass. The carboxylic acid fluoroalkyl ester (3) within the range described above can decrease the viscosity of the nonaqueous electrolyte and improve the injection properties during battery formation. Also, the movement of the reaction product of the trifluoropropionate ester (2), such as difluoroacrylate or the like, to the negative electrode can be suppressed.

The nonaqueous electrolyte may contain a fluorine-containing nonaqueous solvent different from the trifluoropropionate ester (2) and the carboxylic acid fluoroalkyl ester (3). Examples of the fluorine-containing nonaqueous solvent include fluorinated cyclic carbonates. Examples of the fluorinated cyclic carbonates include fluoroethylene carbonate (FEC), fluoropropylene carbonate, and the like.

In general, when the nonaqueous electrolyte contains large amounts of a fluorine-based nonaqueous solvent and an additive, the viscosity is easily increased, and ionic conductivity is easily decreased. By using the fluorinated cyclic carbonate having a high dielectric constant, the dissociation of carrier ions can be accelerated, and the ionic conductivity of the nonaqueous electrolyte can be enhanced. In addition, by using the fluorinated cyclic carbonate, a proper coating film can be formed on the surface of the negative electrode, and thus an excessive increase in resistance can be suppressed. The amount of the fluorinated cyclic carbonate in the nonaqueous electrolyte is, for example, 1% to 30% by mass, preferably 2% to 25% by mass, and more preferably 5% to 20% by mass.

The nonaqueous electrolyte may further contain another nonaqueous solvent not containing fluorine atoms. Examples of the nonaqueous solvent not containing fluorine atoms include cyclic carbonates, chain carbonates, chain esters, lactone, and the like. These other nonaqueous solvents may be used alone or in combination of two or more. In particular, cyclic carbonates are preferred from the viewpoint of obtaining the nonaqueous electrolyte having high ionic conductivity, and propylene carbonate (PC) is particularly preferred in view of its low solidification point. The amount of the other nonaqueous solvent not containing fluorine atoms in the nonaqueous electrolyte, for example, can be selected from 1% to 30% by mass and may be 2% to 20% by mass.

In particular, a combination of PC with the fluorinated cyclic carbonate can maintain the high ionic conductivity of the nonaqueous electrolyte even when the amount of fluorinated cyclic carbonate is decreased by repeating charge and discharge.

For the purpose of improving the charge-discharge characteristics of a battery, an additive may be added to the nonaqueous electrolyte. Examples of the additive include vinylene carbonate (VC), vinylethylene carbonate, cyclohexylbenzene, fluorobenzene, and the like. The amount of the additive in the nonaqueous electrolyte is, for example, 0.01% to 15% by mass and may be 0.05% to 10% by mass.

(Separator)

A porous film containing a resin or a nonwoven fabric can be exemplified as the separator interposed between the positive electrode and the negative electrode. Examples of a resin constituting the separator include polyolefin resins such as polyethylene, polypropylene, ethylene-propylene copolymer, and the like. If required, the porous film may contain inorganic particles. The thickness of the separator is, for example, 5 to 100 μm.

[Nonaqueous Electrolyte Secondary Battery]

The nonaqueous electrolyte secondary battery according to the present invention includes the positive electrode, the negative electrode, the nonaqueous electrolyte, and the separator.

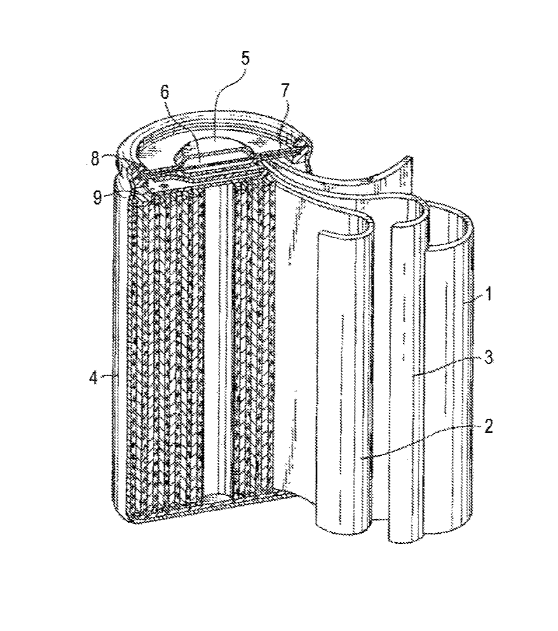

FIG. 1 is a partially exploded perspective view schematically showing a cross-section of the inner structure of the nonaqueous electrolyte secondary battery of the present invention. The nonaqueous electrolyte secondary battery includes a bottomed cylindrical battery case 4 also serving as a negative electrode terminal, and an electrode group and a nonaqueous electrolyte not shown, which are housed in the battery case 4. In the electrode group, a negative electrode 1, a positive electrode 2, and a separator 3 interposed therebetween are spirally wound. A sealing plate 7 provided with a positive electrode terminal 5 and a safety valve 6 is disposed on the opening end of the battery case 4 through an insulating gasket 8. The nonaqueous electrolyte secondary battery is closed by caulking inward the opening of the battery case 4. The sealing plate 7 is electrically connected to the positive electrode 2 through a positive electrode current collector plate 9.

Thus, the nonaqueous electrolyte secondary battery can be produced by housing the electrode group in the battery case 4, injecting the nonaqueous electrolyte, then disposing the sealing plate 7 in the opening of the battery case 4 through the insulating gasket 8, and sealing the opening end of the battery case 4 by caulking. In this case, the negative electrode 1 of the electrode group, in the outermost periphery, comes in contact with the battery case 4 and is electrically connected to the case 4. Also, the positive electrode 2 of the electrode group is electrically connected to the sealing plate 7 through the positive electrode current collector plate 9.

The shape of the nonaqueous electrolyte secondary battery is not particularly limited and may be a cylindrical shape, a flat shape, a coin-like shape, a prismatic shape, or the like.

The nonaqueous electrolyte secondary battery can be produced by a common method according to the battery shape etc. The cylindrical battery or prismatic battery can be produced by, for example, winding the positive electrode 2, the negative electrode 1, and the separator 3, which separates between the positive electrode 2 and the negative electrode 1, to form the electrode group, and housing the electrode group and the nonaqueous electrolyte in the battery case 4.

The electrode group is not limited to a wound type and may be a laminated type or a folded type. The shape of the electrode group may be a cylindrical shape or a flat shape having an oval end surface perpendicular to the winding axis according to the shape of the battery or the battery case 4.

The battery case 4 may be made of a laminate film or made of a metal. Usable examples of a material of the metal-made battery case 4 include aluminum, aluminum alloys (alloys containing a small amount of a metal such as manganese, copper, or the like), a steel plate, and the like.

### EXAMPLES

The present invention is specifically described below based on examples and comparative examples, but is not limited to the examples below.

### Example 1

A nonaqueous electrolyte secondary battery was produced according to procedures described below.

(1) Formation of Positive Electrode

A lithium-nickel composite oxide (NCA) represented by LiNi_{0.82}C_{0.15}Al_{0.03}O₂ was washed with water and then used as a positive electrode active material.

The positive electrode active material was mixed with acetylene black (conductive material) and polyvinylidene fluoride (binder) at a mass ratio of 100:1:0.9, and proper amounts of Li₃PO₄ (phosphate salt) and NMP were added to the resultant mixture to prepare a positive electrode paste. The ratio: S/D of specific surface area S (m²/g) to average particle diameter D (μm) of the Li₃PO₄ used was 50. The content of Li₃PO₄ in a positive electrode mixture was 0.5% by mass. The amount of lithium eluted in water when the positive electrode mixture was washed with water was 0.03% by mass of the positive electrode mixture.

The positive electrode paste was applied to both surfaces of an aluminum foil (positive electrode current collector). The coating films were dried and then rolled by using a rolling roller to form a positive electrode having positive electrode active material layers formed on both surfaces of the positive electrode current collector.

(2) Formation of Negative Electrode

Artificial graphite (negative electrode active material), CMC sodium salt (thickener), and styrene-butadiene rubber (binder) were mixed at a mass ratio of 100:1:1 in an aqueous solution to prepare a negative electrode paste. The resultant negative electrode paste was applied to both surfaces of a copper foil (negative electrode current collector). The coating films were dried and then rolled by using a rolling roller to form a negative electrode having negative electrode active material layers formed on both surfaces of the negative electrode current collector.

(3) Preparation of Nonaqueous Electrolyte

LiPF₆ was dissolved at a concentration of 1.0 M in a mixed solvent prepared by mixing FMP and FEC were at a volume ratio of 85:15, preparing a nonaqueous electrolyte.

(4) Assembly of Nonaqueous Electrolyte Secondary Battery

The positive electrode and negative electrode formed as described above were wound through a separator to form a wound-type electrode group. A porous film made of polyethylene was used as the separator. The electrode group was housed in a battery case, and the nonaqueous electrolyte was injected. Then, an opening of the battery case was caulked to a sealing plate through a gasket. In this way, 10 cylindrical nonaqueous electrolyte secondary batteries were formed. In addition, the positive electrode was welded to the sealing plate through a positive electrode lead, and the negative electrode was welded to the bottom of the battery case through a negative electrode lead.

### Example 21

A nonaqueous electrolyte secondary battery was assembled by the same method as in Example 1 except that the ratio: S/D of specific surface area S (m²/g) to average particle diameter D (μm) of lithium phosphate was 1.

### Example 3

A nonaqueous electrolyte secondary battery was assembled by the same method as in Example 1 except that a nonaqueous electrolyte was prepared by dissolving LiPF₆ at a concentration of 0.8 M and LiFSA at a concentration of 0.2 M in a mixed solvent prepared by mixing FMP and FEC at a volume ratio of 85:15.

### Example 4

A nonaqueous electrolyte secondary battery was assembled by the same method as in Example 1 except that a nonaqueous electrolyte was prepared by dissolving LiPF at a concentration of 1.0 M in a mixed solvent prepared by mixing FMP, FEA, and FEC at a volume ratio of 45:40:15.

### Example 5

A nonaqueous electrolyte secondary battery was assembled by the same method as in Example 1 except that NCA without being washed with water was used as a positive electrode active material.

The amount of lithium eluted in water when the positive electrode mixture was washed with water was 0.11% by mass of the positive electrode mixture.

### Comparative Example 1

A nonaqueous electrolyte secondary battery was assembled by the same method as in Example 1 except that lithium phosphate was not added to a positive electrode mixture.

### Comparative Example 2

A nonaqueous electrolyte secondary battery was assembled by the same method as in Example 1 except that a nonaqueous electrolyte was prepared by using a mixed solvent prepared by mixing ethylmethyl carbonate (EMC) and ethylene carbonate (EC) at a volume ratio of 85:15 as a mixed solvent.

### Comparative Example 3

A nonaqueous electrolyte secondary battery was assembled by the same method as in Example 2 except that a nonaqueous electrolyte was prepared by using a mixed solvent prepared by mixing EMC and EC at a volume ratio of 85:15 as a mixed solvent.

### Comparative Example 4

A nonaqueous electrolyte secondary battery was assembled by the same method as in Comparative Example 1 except that a nonaqueous electrolyte was prepared by using a mixed solvent prepared by mixing EMC and EC at a volume ratio of 85:15 as a mixed solvent.

### Comparative Example 5

A nonaqueous electrolyte secondary battery was assembled by the same method as in Example 3 except that lithium phosphate was not added to a positive electrode mixture.

### Comparative Example 6

A nonaqueous electrolyte secondary battery was assembled by the same method as in Example 4 except that lithium phosphate was not added to a positive electrode mixture.

### Comparative Example 7

A nonaqueous electrolyte secondary battery was assembled by the same method as in Example 5 except that lithium phosphate was not added to a positive electrode mixture.

### Comparative Examples 8 to 13

Nonaqueous electrolyte secondary batteries were assembled by the same methods as in Examples 1 and 2 and Comparative Examples 1 to 4, respectively, except that LiCoO₂ (LCO) was used as a positive electrode active material.

(5) Evaluation

The batteries produced in Examples 1 to 5 and Comparative Examples 1 to 13 were measured for the initial discharge capacity, variation in open-circuit voltage (OCV) after finishing, and high-temperature cycle characteristics.

(a) Initial Discharge Capacity

The battery formed was charged at a constant current of 0.2 It (650 mA) until the voltage became 4.2 V. Next, the battery was charged at a constant voltage of 4.2 V until the current became 0.02 It (65 mA) and then discharged at a constant current of 0.2 It (650 mA) until the voltage became 3.0 V. In this case, a value obtained by dividing the capacity by the mass of the positive electrode active material was regarded as the initial discharge capacity.

Assuming that the average value of the initial discharge capacities of the 10 batteries formed in Comparative Example 1 was 100, the average value of the initial discharge capacities of the 10 batteries formed in each of the examples and the comparative examples was determined. The results are shown in Table 1 and Table 2.

(b) Variation in Open-Circuit Voltage (OCV)

Variation was determined by measuring the open-circuit voltages of the 10 batteries in each of the examples and the comparative examples. The open-circuit voltages were measured after the passage of 20 minutes from the measurement of the initial discharge capacity. The variation was calculated as the standard deviation of the 10 batteries.

Assuming that the variation in open-circuit voltage of the batteries formed in Comparative Example 1 was 100, the variation in open-circuit voltage of the batteries formed in each of the examples and the comparative examples was determined. The results are shown in Table 1 and Table 2.

(c) High-Temperature Cycle Characteristics

The charge-discharge described above in (a) was repeated 600 times at 45° C. The capacity retention rate after 600 cycles was determined by the following formula.

Capacity retention rate (%)=(discharge capacity after 600 cycles)/discharge capacity at first cycle)×100

The average value of the capacity retention rates of the 10 batteries formed in each of the examples and the comparative examples is shown in Table 1 and Table 2.

TABLE 1

| | | Positive electrode | | | | | | | | |
|---|---|---|---|---|---|---|---|---|---|---|
| | | | | | Amount | | | | | |
| | | | | | of | Nonaqueous | | | | |
| | | Positive | | | lithium | electrolyte | | | | |
| | | electrode | | | eluted | Non- | | Initial | | Capacity |
| | | active | Phosphate | Phosphate | (% by | aqueous | Lithium | discharge | OCV | retention |
| | | material | salt | salt S/D | mass) | solvent | salt | capacity | variation | rate (%) |
| Ex- | 1 | NCA | Yes | 50 | 0.03 | FMP/FEC = | 1.0M LiPF₆ | 100 | 75 | 92 |
| am- | 2 | | | 1 | | 85/15 | | 100 | 85 | 90 |
| ple | 3 | | Yes | 50 | 0.03 | FMP/FEC = | 0.8M LiPF₆ | 101 | 72 | 93 |
| | | | | | | 85/15 | 0.2M LiFSA | | | |
| | 4 | | Yes | 50 | 0.03 | FMP/FEA/FEC = | 1.0M LiPF₆ | 101 | 74 | 91 |
| | | | | | | 45/40/15 | | | | |
| | 5 | | Yes | 50 | 0.11 | FMP/FEC = | 1.0M LiPF₆ | 100 | 85 | 92 |
| | | | | | | 85/15 | | | | |
| Com- | 1 | NCA | No | — | 0.03 | FMP/FEC = | 1.0M LiPF₆ | 100 | 100 | 90 |
| par- | | | | | | 85/15 | | | | |
| ative | 2 | | Yes | 50 | 0.03 | EMC/EC = | 1.0M LiPF₆ | 99 | 90 | 65 |
| Ex- | 3 | | | 1 | | 85/15 | | 100 | 85 | 68 |
| am- | 4 | | No | — | 0.03 | EMC/EC = | 1.0M LiPF₆ | 100 | 79 | 70 |
| ple | | | | | | 85/15 | | | | |
| | 5 | | No | — | 0.03 | FMP/FEC = | 0.8M LiPF₆ | 101 | 98 | 91 |
| | | | | | | 85/15 | 0.2M LiFSA | | | |
| | 6 | | No | — | 0.03 | FMP/FEA/FEC = | 1.0M LiPF₆ | 100 | 98 | 89 |
| | | | | | | 45/40/15 | | | | |
| | 7 | | No | — | 0.11 | FMP/FEC = | 1.0M LiPF₆ | 98 | 120 | 88 |
| | | | | | | 85/15 | | | | |

TABLE 2

| | | Positive electrode | | | | | | | |
|---|---|---|---|---|---|---|---|---|---|
| | | Positive | | | Nonaqueous electrolyte | | | | |
| | | electrode | | | Non- | | Initial | | Capacity |
| | | active | Phosphate | Phosphate | aqueous | Lithium | discharge | OCV | retention |
| | | material | salt | salt S/D | solvent | salt | capacity | variation | rate (%) |
| Comparative | 8 | LCO | Yes | 50 | FMP/FEC = | 1.0M LiPF₆ | 69 | 75 | 88 |
| Example | 9 | | | 1 | 85/15 | | 69 | 73 | 89 |
| | 10 | | No | — | | | 70 | 70 | 90 |
| | 11 | | Yes | 50 | EMC/EC = | 1.0M LiPF₆ | 70 | 75 | 78 |
| | 12 | | | 1 | 85/15 | | 71 | 70 | 79 |
| | 13 | | No | — | | | 72 | 63 | 80 |

Table 1 and Table 2 indicate that when NCA containing nickel is used as the positive electrode active material (Examples 1 to 5 and Comparative Examples 1 to 7), the battery produced has high initial discharge capacity as compared with when LCO not containing nickel is used (Comparative Examples 8 to 13). On the other hand, when NCA is used, the variation in OCV is increased as compared with when LCO is used.

However, it is found that in Example 1 and Example 2 in which lithium phosphate is added to the positive electrode and the nonaqueous electrolyte contains FMP, the variation in OCV is suppressed as compared with Comparative Example 1 in which lithium phosphate is not added. The same result can be confirmed from comparison between Examples 3 to 5 and Comparative Examples 5 to 7. This is considered to be due to the fact that the reaction products of the alkali components remaining in the positive electrode active material with FMP is suppressed from moving to the negative electrode by lithium phosphate, and thus the coating film on the negative electrode is made uniform. The results of Comparative Examples 2 to 4 indicate that the effect obtained by adding lithium phosphate cannot be obtained when the nonaqueous electrolyte does not contain FMP.

Even in Example 5 using the positive electrode active material not washed with water, the variation in OCV is suppressed as compared with Comparative Example 7 in which lithium phosphate is not added. Thus, even when a large amount of lithium remains in the positive electrode, the effect obtained by adding lithium phosphate can be obtained. Also, it can be confirmed that the batteries of Examples 1 to 5 have high capacity retention rates even after 600 repetitions of charge and discharge at 45° C. and show excellent high-temperature cycle characteristics.

### INDUSTRIAL APPLICABILITY

A nonaqueous electrolyte secondary battery according to the present invention has a good coating film formed on a negative electrode even when using a positive electrode active material with a high nickel content, and thus can suppress variation in open-circuit voltage between batteries. Further, the nonaqueous electrolyte secondary battery according to the present invention has a high initial discharge capacity and high-temperature characteristics. Therefore, the nonaqueous electrolyte secondary battery is useful as a secondary battery used for a cellular phone, a personal computer, a digital still camera, a game device, a portable audio device, an electric car, etc.

### REFERENCE SIGNS LIST

1: negative electrode
2: positive electrode
3: separator
4: battery case
5: positive electrode terminal
6: safety valve
7: sealing plate
8: insulating gasket
9: positive electrode current collector plate

1. A nonaqueous electrolyte secondary battery comprising:
a positive electrode containing a positive electrode mixture;
a negative electrode; and
a nonaqueous electrolyte containing a nonaqueous solvent and a lithium salt dissolved in the nonaqueous solvent,
wherein the positive electrode mixture contains a positive electrode active material and a phosphate salt;
the positive electrode active material contains a lithium-nickel composite oxide represented by formula (1): LiₓNi_{1-y}M1_{y}O₂ (in the formula, 0.9≤x≤1.1, 0≤y≤0.7, and M1 is at least one element selected from the group consisting of Co, Mn, Fe, Ti, Al, Mg, Ca, Sr, Zn, Y, Yb, Nb, Cr, V, Zr, Mo, W, Cu, In, Sn, and As); and
the nonaqueous solvent contains a trifluoropropionate ester represented by formula (2): 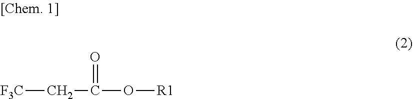
(in the formula, R1 is a C₁₋₃ alkyl group); and
the ratio: S/D of the specific surface area S (m²/g) to the average particle diameter D (μm) of the phosphate salt is 5 or more.

2. The nonaqueous electrolyte secondary battery according to claim 1, wherein the phosphate salt is lithium phosphate.

3. The nonaqueous electrolyte secondary battery according to claim 1, wherein the ratio of the phosphate salt in the positive electrode mixture is 0.01% to 10% by mass.

4. The nonaqueous electrolyte secondary battery according to claim 1, wherein the ratio of the trifluoropropionate ester in the nonaqueous solvent is 10% by volume or more.

5. The nonaqueous electrolyte secondary battery according to claim 1, wherein the nonaqueous electrolyte further contains a carboxylic acid fluoroalkyl ester represented by formula (3), 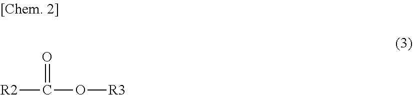
(in the formula, R2 represents a C₁₋₃ alkyl group, and R3 represents a fluorinated C₁₋₃ alkyl group).

6. The nonaqueous electrolyte secondary battery according to claim 1, wherein the nonaqueous electrolyte contains lithium bis(fluorosulfonyl)amide.

7. The nonaqueous electrolyte secondary battery according to claim 1, wherein the amount of lithium eluted in water is 0.01% to 0.2% by mass of the positive electrode mixture when the positive electrode mixture is dispersed in pure water.
